(19) United States
(12) Patent Application Publication
(10) Pub. No.: US 2012/0314076 A1
(43) Pub. Date: Dec. 13, 2012

(54) SECURITY SYSTEM AND METHOD OF USING A SELF-SERVICE TERMINAL

(76) Inventors: Wilton RUAS DA SILVA, Sao Paulo (BR); Geovane DE GODOI, Sao Paulo (BR); Roberto MASSAYOSHI HONDA, Sao Paulo (BR); Edmur MORAES FILHO, Sao Paulo (BR); Milton SHIZUO NOGUSHI, Sao Paulo (BR)

(21) Appl. No.: 13/488,663

(22) Filed: Jun. 5, 2012

(30) Foreign Application Priority Data
Jun. 9, 2011 (BR) PI 1102868-8

(51) Int. Cl. H04N 7/18

(52) U.S. Cl. 348/156; 348/E07.085

(57) ABSTRACT

The present invention refers to a security system and a method of using a self-service terminal, which are capable of increasing the levels of security, principally, while carrying out banking transactions, since they eliminate the need for physical contact with keyboards and touch-sensitive screens for selecting functions and typing data exclusive to the user.

### FIELD OF THE INVENTION

The present invention refers to a security system and a method of using self-service terminals, preferably those used for banking transactions at bank branches and kiosks, also known as ATM.

More particularly, the present invention refers to a security system and a method of use applied to self-service banking terminals whose man-machine interface is carried out by recognizing user movements and gestures, that is, without the need for peripherals such as keyboard, touch-sensitive screens, etc. Additionally, according to the system of the present invention, it is possible to increase the levels of security during banking transactions and, consequently, effectively reduce the fraud and information theft indices.

### BACKGROUND OF THE INVENTION

Currently, and particularly in the banking activity sector, there is growing concern for the security of banking transactions, either in the use of security means in money notes and credit/debit cards, or in the installation and use of software and equipment to guarantee the safety of bank employees, as well as clients during banking transactions. This is because, as those skilled in the art will know, there are many criminals who seek alternative forms to dribble and fraud all these security means to harm other people.

Particularly in relation to banking transaction equipment, currently known as ATM or self-service terminals, it is noted that although they comprise elements and devices designed to avoid such fraud, it is known that criminals use countless alternative forms capable of obtaining user transaction data. Such weaknesses often occur by virtue of the interface used by the user at self-service terminals.

The self-service terminals known in the state of the art normally comprise keyboards for typing data and monitors to guide navigation and choice of activities the user wishes to process at these terminals. More up-to-date equipment uses touch-sensitive screens (touch screen), by which it is possible to conduct all the user navigation while carrying out banking transactions.

In the case of security, it is known that this equipment comprises software and devices, of the chip kind, installed in credit/debit cards which, combined with digital passwords, certify the owner of the card in order to qualify him to carry out the transaction, for example, withdrawal, transfer of amounts and payment of bills. Further, said software is developed so as to dispose on the touch-sensitive screens combinations of numbers, which are periodically altered to avoid easy memorization of numbers.

More specifically, the tools currently applied are designed to increase the levels of security during banking transactions, principally to thwart or avoid fraud by criminals.

Nevertheless, although a series of measures have been adopted by banks and users to guarantee the security of these transactions, it is known that said criminals are capable of substituting and/or cloning the card insertion mechanisms to obtain user data, and also changing the conventional keyboards so as to permit user passwords to be memorized. Accordingly, criminals manage to access the user's account, passing themselves off as the user, and unlawfully use the data to withdraw and divert money.

Another currently known form of obtaining exclusive data of users is by installing film and photographic cameras capable of recording user passwords when users are carrying out the respective banking transaction. This form of obtaining data has been widely applied because the touch-sensitive screens exhibit pairs of numbers, which although compiled at random, the cameras manage to record, at least, those pairs of numbers selected by the users and, accordingly, criminals can type the same sequence of data by trial and error.

Furthermore, it is noted that although these touch-sensitive screens present a somewhat limited angle of visibility of the information displayed, this limitation is not enough to avoid recording by cameras and/or by the criminals themselves who may stand near the user and note the sequence of numbers typed.

Additionally, another drawback noted in self-service terminals is in relation to hygiene and health of the users when typing on the keyboards and/or using the touch-sensitive screen. This is because, as will be appreciated by those skilled in the art, this equipment is handled by countless users, who, even unconsciously, ultimately carry dirt, bacteria and microbes, which are easily transmitted by contact.

In this sense, it is noted that an initial user of the terminal may transmit diseases and bacteria to the following users, since typing the keys and/or handling the touch-sensitive screen will promote contamination of the keyboard and the screen, such that the following user will touch these same devices that might be contaminated.

In light of the above, it is important to clarify that the banking safety equipment and devices currently known in the state of the art still bear vulnerable points in terms of security against criminality, principally because they still allow the unlawful obtainment of data exclusive to the user, which will likely not be solved by current technology alone. Besides security, it is noted that the current terminals, especially for banking transactions, reveal drawbacks related to public health for permitting easy contamination and proliferation of bacteria between the users.

### SUMMARY OF THE INVENTION

Therefore, the objective of the present invention is a security system applied to equipment of the self-service terminal kind for banking transactions capable of reducing or eliminating in an efficient manner the drawbacks and limitations of the banking security equipment and devices of the state of the art.

More specifically, the objective of the present invention is a security system applied to self-service terminals which eliminates physical or virtual keyboards displayed on touch-sensitive screens, and all the control and handling of the functions and banking transactions are chosen and selected by user gesture movement.

A further objective of the present invention is a security system that eliminates the unlawful recording of the options selected by the user, since the visualization of the functions and options displayed are perceptible only by the user, and any observer positioned near the terminal will perceive only the user's movement and gesticulation.

A yet further objective of the present invention is a security system that eliminates physical contact of the user at the self-service terminal, since all handling is simply by gestures, without the need to touch the equipment.

Additionally, it is an objective of the present invention to provide a method of using self-service banking terminals carried out solely by movement and gesticulation by the user, preventing third parties from visualizing and/or recording the user's exclusive data.

Moreover, the purpose of said method of use is to control and access all the functions necessary for carrying out banking transactions, without the need of any physical contact between the user and the self-service terminal.

Therefore, it is important to emphasize that the purpose of the present invention is a security system and a method of using self-service terminals, especially banking terminals, which recognize gestures of the users and executes operating procedures relating to the movement and/or gesture.

### BRIEF DESCRIPTION OF THE DRAWINGS

These and other objectives, technical effects and advantages of the security system and the method of using the banking transaction equipment, according to the present invention, will be apparent to persons skilled in the art, based on the detailed description below containing references to the accompany schematic drawings, which illustrate exemplificatory and non-limitative embodiments of the present invention.

FIGS. 1A and 1B show schematic view of a self-service type terminal equipment having a security system according to the present invention;

FIG. 2 shows an alternative embodiment of the security system applied to a self-service terminal;

FIG. 3 shows a schematic view of a parameterization screen of the system and method according to the present invention;

FIGS. 4a to 4c schematically show a simulation of the security system and the method of use according to the present invention.

### DETAILED DESCRIPTION OF THE INVENTION

Initially, it must be emphasized that the security system applied to self-service terminals and the method of using this equipment, according to the present invention, will be described below according to preferred and non-limitative embodiments, since their applications and concretizations may be carried out in different ways and in accordance with the application desired by the person skilled in the art to attribute the security needed during interface between man and machine.

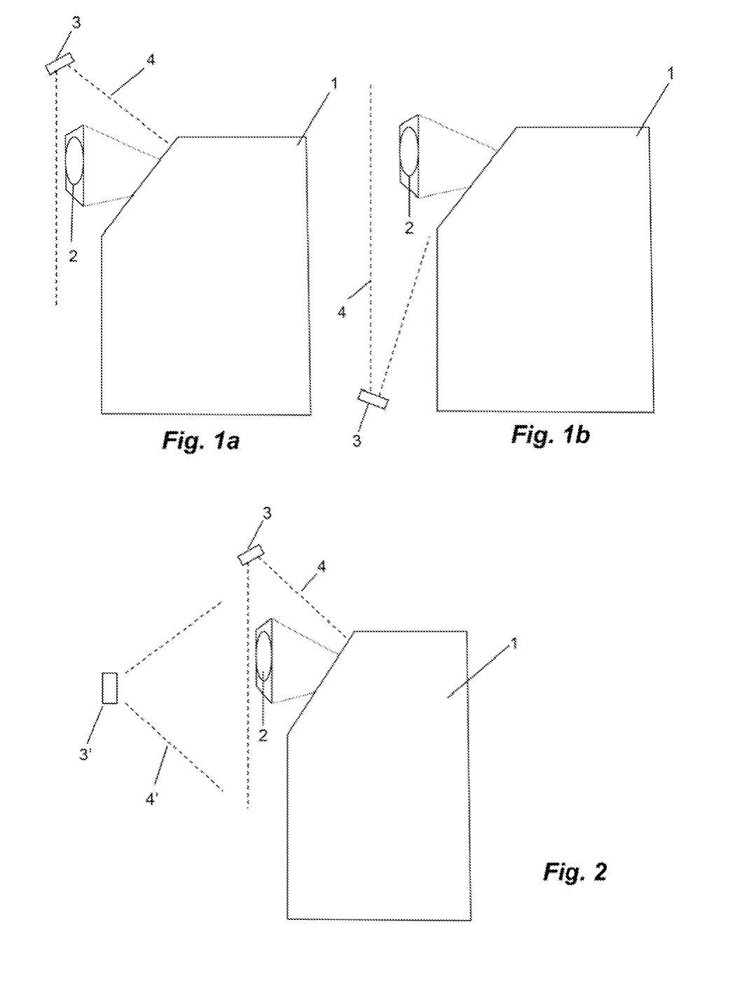

Therefore, according to the accompanying figures, particularly in relation to FIG. 1, the security system applied to self-service terminals comprises an image-generating device capable of projecting the functions and icons perceptible only to the user duly positioned in front of the equipment 1, also having a region of interest 2 disposed in front of the equipment 1, on which there is a movement-detecting camera 3 with field of visualization 4 focused on said region of interest 2.

More specifically, said region of interest 2 is destined for positioning the user's hand, which will be detected by the camera 3, and it will be in this region of interest 2 that the user will make all the gestures to select and confirm the functions projected by the image-generating device of the security system, according to the present invention.

Therefore, according to the present invention, a movement-detecting camera 3 is arranged to capture images of the user's hand inside the region of interest 2, which remains in the field of visualization 4. Said camera 3 detects the movements made by the user's hand by using image treatment algorithms.

According to FIGS. 1A and 1B, it is noted that said detector camera 3 can be installed both in the upper region of the equipment 1, as illustrated in FIG. 1A, as in an alternative and equivalent embodiment, said camera 3 can be positioned in the lower region of the equipment, as indicated in FIG. 1B. In both cases, it is important to highlight that the field of visualization 4 of the camera 3 should be focused towards the region of interest 2, where the user makes the gestures for handling the equipment 1.

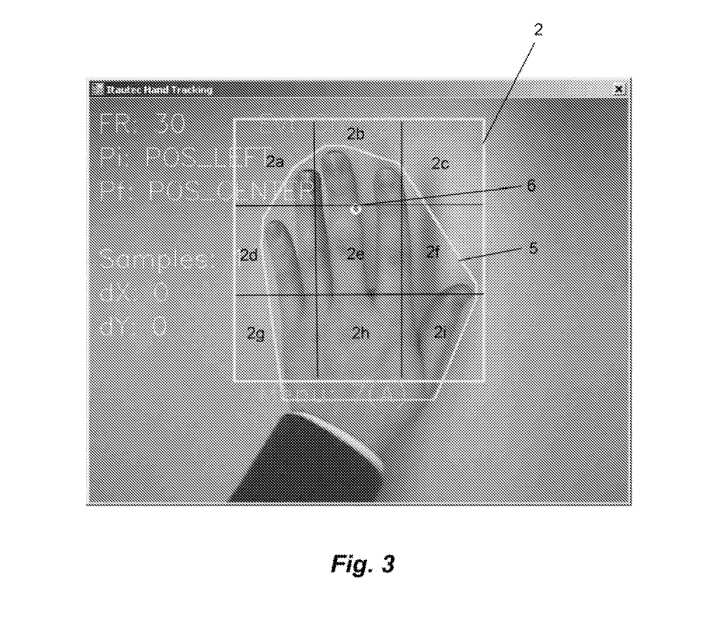

Particularly with reference to FIG. 3, the image treatment algorithms establish that the region of interest 2 is promoted from a virtual division into quadrants, through which it is possible to determine the position of the user's hand and establish an area 5 relative to the occupation of the hand, inside of which it is possible to determine a cursor point 6 disposed in a median region of the user's hand. The purpose of this cursor point is to promote a reference to the security system.

Accordingly, after establishing and defining the region of interest 2 and the area of occupation 5 of the user's hand, the security system of the present invention determines the parameterization and the virtual division of said region of interest 2, preferably, into nine quadrants 2a, 2b, 2c, 2d, 2e, 2f, 2g, 2h and 2i, respectively, relating to the following quadrants: upper left, upper middle, upper right, left, middle, right, lower left, lower middle and lower right.

With the determination of these nine quadrants inside the area of interest 2, it is possible to record the quadrant 2e where the indication of the cursor 6 is found, this quadrant being defined as initial position “Ip”, whereafter, a final position “Fp”, or final quadrant is determined and recorded, established by virtue of the last quadrant in which the user's hand is detected inside the region of interest 2. With these two values, “Ip” and “Fp”, it is possible to determine where the hand entered and where the hand exited the region of interest 2, and based on this data, the security system of the present invention determines rules and procedures for generating events corresponding to each application.

For example, if the hand entered into one of the quadrants on the left 2c, 2f and 2i, and exited one of the quadrants on the right 2a, 2d and 2g, the security system detects that the user made a gesture to move the objects in the space to the right, whereby generating a signal equivalent to the event “arrow rightwards”. In the same way, if the systems detects that the user's hand entered into one of the quadrants on the right 2a, 2d and 2g, leaving out of the quadrants on the left 2c, 2f and 2i, the security system of the present invention understands that the user made a gesture to move the objects in the space to the left, and generates a signal equivalent to the event “arrow leftwards”.

Lastly, according to the system of the present invention, particularly in the embodiment illustrated in FIG. 1, the camera may also detect the “forward” and “backward” movement, that is, an advance and retreat movement in relation to the region of interest 2 of the security system. By way of this movement, the security system detects the user's intention to select a certain function and/or icons projected.

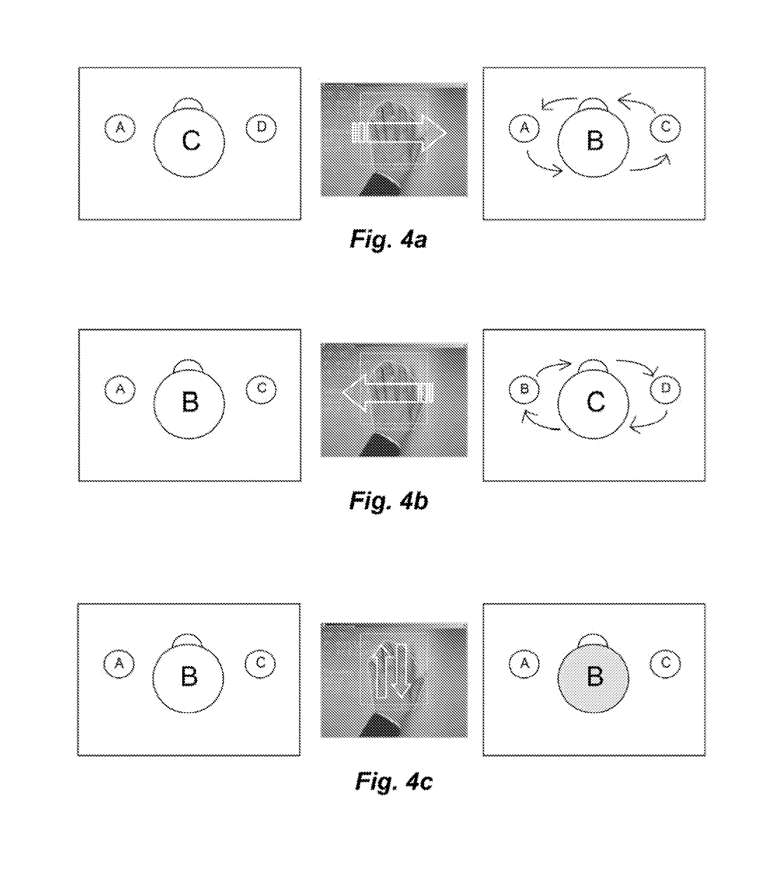

These movements and gestures by the user are more easily perceptible by analyzing FIGS. 4a and 4c, in which examples of screens and images are illustrated, combined with the respective gestures of the user during handling of the self-service terminal equipment.

More specifically, it is noted in FIG. 4a that the image-generating device of the equipment 1 projects the icons and functions “B”, “C” and “D”, highlighting item “C” which is centralized on the screen. With the movement of the user's hand from left to right (pursuant to indicative arrow), the movement-detecting camera 3 records that the hand entered into one of the quadrants on the left 2c, 2f and 2i of the area of interest 2, and exited one of the quadrants on the right 2a, 2d and 2g of the area of interest 2. Therefore, the security system detects the gesture made by the user, making the functions and icons turn, such that item “B” enters into the highlight spot of item “C” previously highlighted.

FIG. 4b carries out the procedure in which the user's hand moves in the opposite direction to that of FIG. 4a, that is, the user's hand enters into the quadrants from the right 2a, 2d and 2g and exits the quadrants on the left 2c, 2f and 2i. Accordingly, it is noted that the functions and icons are moved in the direction of the arrow to the left, whereby item “C” returns to the previously highlighted spot.

FIG. 4c is a situation in which the user moved the functions and icons and, when it identified the one of interest, it carries out an advance and retreat movement in relation to the equipment, whereby the detector camera 3 is capable of recording the “forward” and “backward” movement in the area of interest 2, such that the security system detects the user's interest in selecting that certain function and/or icon.

In a preferred embodiment of the present invention, the functions and icons are projected such that they are highlighted in relation to the generating device, as if they were floating in a region visually perceptible only to the user positioned in front of the equipment. More preferably, this image generator is capable of projecting aerial images in 3D, which can only be observed from the angle of vision of the user immediately disposed in front of the equipment.

Furthermore, said image-generating device can be an apparatus or equipment of personal use, such as tablets or cellphones, whose images are transferred by means of wireless technology, for example via Bluetooth or Wireless, or other wire or wireless transmission means, though it is essential that the projection of the images is done in such a way that only user can visualize them.

Further, according to an embodiment that requires less financial investment, the image generator may be a conventional display, where the images are presented in 2D. However, logically, said display will be positioned so as to prevent clear visualization of the functions and icons.

Alternatively, it is possible to dispose a second detector camera 3′ capable of recording the movement of the upward and downward gestures of the user. In this embodiment, said camera 3′ has a field of visualization 4′ detects the region of interest 2 from the side angle, whereby it becomes possible to detect and record the movements of the user's hand in a three-dimensional arrangement, that is, on the three axes of the Cartesian system (x, y, z).

It is important to highlight that the security system of the present invention generates the images of the functions and icons so that only the user is capable of visualizing them, and all accesses are carried out by means of gestures detected by the camera 3 inside the area of interest 2. Accordingly, it is noted that any person positioned near or in the proximity of the user will only perceive the movement and gesticulation of the user, avoiding fraud and unlawful recording of the user's exclusive data.

Additionally, the present invention refers to a method of using a self-service terminal, which comprises a security system through which the user carries out all transactions with simple gestures, without the need of having any physical contact with the equipment.

More particularly, the method of using self-service terminals, according to the present invention, is comprised by the following steps:

i) detecting the user in front of the self-service terminal;

ii) projecting images related to the functions and icons in an exclusive area for visualization only by the user positioned in front of the terminal;

iii) determining the region of interest 2, comprising the identification and positioning of the user's hand inside the region of interest 2, which is virtually divided quadrants;

iv) movement of the functions and icons projected by user hand gesticulation inside the region of interest 2 in right-left and left-right directions;

v) selecting the function and/or icon desired by user hand gesticulation inside the region of interest 2 in forward and backward directions.

In a preferred advantageous embodiment, the region of interest 2 is divided into nine quadrants 2a, 2b, 2c, 2d, 2e, 2f, 2g, 2h and 2i, respectively, upper left, upper middle, upper right, left, middle, right, lower left, lower middle and lower right.

Further, in another preferred embodiment of the present invention, the images generated and projected in step (ii) are formed by way of an aerial image-generating device in 3D, which is installed inside the self-service terminal and the projection of the images is limited to an exclusive space of the terminal that prevents visualization by third parties present in the proximity of the user.

More particularly, step (iii) comprises the determination of the virtual quadrants which divide the region of interest 2, determining the quadrant 2e where the indication of the cursor 6 is found, this quadrant being defined as initial position “Ip”, thereafter, the final position “Fp”, or final quadrant is determined and recorded, which is established at the last moment in which the hand is detected inside the region of interest. With these two values, “Ip” and “Fp”, it is possible to determine where the hand entered and where the hand exited the region of interest 2.

Thus, in light of the information mentioned above as exemplificatory of the present invention, it is important to highlight that the security system and the method of using the self-service terminal recognize gestures and execute operating procedures relating exclusively to the movements made by the user.

In this sense, it must be clear that the present invention seeks to solve limitations and security problems currently existing due to the fragility of the self-service terminals that require handling and physical contact between the user and the equipment. Therefore, with the use of gestures it is possible to guarantee an increase in the levels of security for operating the terminal, avoiding and/or even eliminating the risk that cameras and/or false keyboards manage to record the user's exclusive data, since the manipulation by gestures allows the selection of the password and functions relating to the use of the terminal, through the image presented only to the user.

Additionally, another advantage of the present invention is in relation to hygiene, as it avoids touching the keyboards or display with virtual keyboard (which facilitates the transmission of diseases and viruses). The sole point of contact of the user with the self-service terminal of the present invention is only at the moment of withdrawing money. Other than this, the user has no contact at all.

Hence, although the description of the preferred embodiment above makes reference to the self-service terminals, especially, for banking transactions, the security system and method of use, according to the present invention, can be used for any purpose that a person skilled in the art will know how to make the due adaptations by using means equivalent to those defined in the present specification and accompanying claims.

This application incorporated by reference the application to which it claims Paris Convention priority, which is Brazilian application PI 1102868-8 filed 9 Jun. 2011 In the name of ITAUTEC S/A-GRUPO ITAUTEC, for “SECURITY SYSTEM AND METHOD OF USING A SELF-SERVICE TERMINAL”.

1. A SECURITY SYSTEM, applied to self-service terminals, characterized by comprising an image-generating device capable of projecting the functions and icons perceptible only to the user duly positioned in front of the equipment (1), also having a region of interest (2) disposed in front of the equipment (1), on which there is a field of visualization (4) of a movement-detecting camera (3) focused on the region of interest (2).

2. A SYSTEM, according to claim 1, characterized by the fact that said region of interest (2) is the site of positioning of the user's hand, on which the movements and selection gestures will be detected and the functions and icons projected by the image generator will be confirmed.

3. A SYSTEM, according to claim 1, characterized by the fact that the movement-detecting camera (3) is arranged to capture images of the user's hand over the region of interest (2), said detection being carried out by means of image treatment algorithms.

4. A SYSTEM, according to claim 1, characterized by the fact that the movement-detecting camera (3) is installed in the upper or lower region of the equipment (1).

5. A SYSTEM, according to claim 1, characterized by the fact that said region of interest (2) comprises a virtual division into quadrants by which the position of the user's hand is determined.

6. A SYSTEM, according to claim 5, characterized by the fact that the region of interest (2) comprises a hand occupation area (5), inside of which a cursor point (6) is determined as movement reference.

7. A SYSTEM, according to claim 5, characterized by the fact that the virtual division of said region of interest (2) comprises nine quadrants (2a, 2b, 2c, 2d, 2e, 2f, 2g, 2h and 2i), respectively, upper left, upper middle, upper right, left, middle, right, lower left, lower middle and lower right.

8. A SYSTEM, according to claim 7, characterized by the fact that the region of interest (2) comprises an initial position (Ip), determined by the quadrant (2e) on which the cursor point (6) is positioned, and a final position (Fp), which is determined by the quadrant in which the user's hand was last detected inside the region of interest (2).

9. A SYSTEM, according to claim 8, characterized by the fact that the initial and final positions, (Ip) and (Fp), determine the user's intention by detecting where the hand entered and where the hand exited the region of interest (2).

10. A SYSTEM, according to claim 1, characterized by the fact the functions and icons are projected so that they are highlighted, floating, in relation to the image-generating device.

11. A SYSTEM, according to claim 1, characterized by the fact that the image generator projects aerial images in 3D.

12. A SYSTEM, according to claim 1, characterized by the fact that said image-generating device can be an apparatus or equipment of personal use, such as tablets or cellphones, wherein the images are transferred by wire or wireless technology.

13. A SYSTEM, according to claim 1, characterized by the fact that said image-generating device is a conventional display installed in the equipment (1).

14. A SYSTEM, according to claim 1, characterized by comprising a second detector camera (3′) having a field of visualization (4′) that corresponds to the side view of the region of interest (2).

15. A METHOD OF USING A SELF-SERVICE TERMINAL, characterized by comprising the following steps:
i) detecting the user in front of the self-service terminal;
ii) projecting images related to the functions and icons in an exclusive area for visualization only by user positioned in front of the terminal;
iii) determining the region of interest (2), comprising identifying and positioning the user's hand inside the region of interest (2), which is virtually divided into quadrants;
iv) moving the functions and icons projected by gesturing the user's hand inside the region of interest (2) from right to left and from left to right;
v) selecting the desired function and/or icon by gesturing the user's hand inside the region of interest (2) forwardly and backwardly.

16. A METHOD, according to claim 15, characterized by the fact that the region of interest (2) is divided into nine quadrants (2a, 2b, 2c, 2d, 2e, 2f, 2g, 2h and 2i), respectively, upper left, upper middle, upper right, left, middle, right, lower left, lower middle and lower right.

17. A METHOD, according to claim 15, characterized by the fact that the images generated and projected in step (ii) are formed from an image-generating device in 3D, and whose images are only visualized by the user himself.

18. A METHOD, according to claim 15, characterized by the fact that step (iii) is comprised by determining the virtual quadrants that divide the region of interest (2), determining the quadrant (2e) with the indication of the cursor (6), this quadrant being defined as initial position (Ip), next, the final position (Fp), or final quadrant is determined and recorded, established by the last moment in which the hand is detected inside the region of interest.

19. A METHOD, according to claim 18, characterized by the fact that by way of values, (Ip) and (Fp), it is determined where the user's hand entered and where it exited the region of interest (2).
